(19) United States
(12) Patent Application Publication
(10) Pub. No.: US 2016/0342269 A1
(43) Pub. Date: Nov. 24, 2016

(54) TACTILE SENSATION PROVIDING APPARATUS AND SYSTEM

(71) Applicant: FUJITSU LIMITED, Kawasaki-shi (JP)

(72) Inventors: Yasuhiro ENDO, Ebina (JP); Yuichi Kamata, Isehara (JP); Kiyoshi Taninaka, Ebina (JP); Akinori Miyamoto, Sagamihara (JP)

(73) Assignee: FUJITSU LIMITED, Kawasaki-shi (JP)

(21) Appl. No.: 15/229,847

(22) Filed: Aug. 5, 2016

Related U.S. Application Data
(63) Continuation of application No. PCT/JP2014/053458, filed on Feb. 14, 2014.

(51) Int. Cl. G06F 3/041; G06F 3/01

(52) U.S. Cl. CPC G06F 3/0416; G06F 3/016; G06F 3/0412

(57) ABSTRACT

A tactile sensation providing apparatus includes a top panel having a manipulation input surface; a position detector configured to detect a position of a manipulation input; a first vibrating element; a memory configured to store tactile sensation data in which an image of a target tangible object is associated with positions in the image and amplitudes corresponding to tactile sensations of the target tangible object at the respective positions; and a drive controlling part configured to drive the first vibrating element by using a driving signal. The tactile sensation data, downloaded by a mobile terminal of a user from a server via a network, is input from the mobile terminal of the user. The drive controlling part adjusts an amplitude of the driving signal based on the position of the manipulation input and a position among the positions in the image included in the tactile sensation data.

### CROSS-REFERENCE TO RELATED APPLICATION

This application is a continuation application of International Application PCT/JP2014/053458 filed on Feb. 14, 2014 and designated the U.S., the entire contents of which are incorporated herein by reference.

### FIELD

The embodiments discussed herein relate to a tactile sensation providing apparatus and a system.

### BACKGROUND

A tactile sensation producing apparatus is known in the related art which includes a display, a contact detector that detects a contact state of user's manipulation to the display and a haptic vibration generating part which generates haptic vibration that gives a designated sensation to the user's body-part contacting the display (for example, see Patent Document 1).

The tactile sensation producing apparatus further includes a vibration waveform data generating means which generates a waveform data based on a detected result of the contact detector. The waveform data is used to generate the haptic vibration. The tactile sensation producing apparatus further includes an ultrasound modulating means which performs a modulating process on the waveform data, generated by the vibration waveform data generating means, by utilizing ultrasound as a carrier wave and outputs an ultrasound signal generated by the modulating process to the haptic vibration generating means as a signal used to generate the haptic vibration.

The ultrasound modulating means performs either a frequency modulation or a phase modulation. The ultrasound modulating means further performs an amplitude modulation.

However, an ultrasound frequency used in the conventional tactile sensation producing apparatus may be any frequency as long as the frequency is higher than that of an audio frequency (about 20 kHz). No specific setting is made for the ultrasound frequency. Accordingly, the tactile sensation producing apparatus does not provide a fine tactile sensation to the user.

### RELATED-ART DOCUMENTS

### Patent Documents

[Patent Document 1] Japanese Laid-open Patent Publication No. 2010-231609

### SUMMARY

According to an aspect of the embodiments, a tactile sensation providing apparatus includes a top panel having a manipulation input surface; a position detector configured to detect a position of a manipulation input performed on the manipulation input surface to output a signal in accordance with the manipulation input; a display part disposed on a back face side of the top panel; a first vibrating element configured to generate a vibration in the manipulation input surface of the top panel; a memory configured to store tactile sensation data in which an image of a target tangible object is associated with positions in the image and amplitudes corresponding to tactile sensations of the target tangible object at the respective positions; and a drive controlling part configured to drive the first vibrating element by using a driving signal causing the first vibrating element to generate a natural vibration in an ultrasound-frequency-band in the manipulation input surface. The tactile sensation data, downloaded by a mobile terminal of a user from a server via a network, is input from the mobile terminal of the user. The drive controlling part adjusts an amplituide of the driving signal based on the position of the manipulation input performed on the manipulation input surface and a position among the positions in the image included in the tactile sensation data.

### BRIEF DESCRIPTION OF DRAWINGS

FIG. 1 is a diagram illustrating an example of a mode of using a tactile sensation providing apparatus according to a first embodiment;

FIG. 2 is a diagram illustrating the tactile sensation providing apparatus of the first embodiment in plan view;

FIG. 3 is a diagram illustrating a cross-sectional view of the tactile sensation providing apparatus taken along a line A-A of FIG. 2;

FIG. 4A is a diagram illustrating crests and troughs of a standing wave formed in parallel with a short side of a top panel;

FIG. 4B is a diagram illustrating the crests and the troughs of the standing wave formed in parallel with the short side of the top panel;

FIG. 5A is a diagram illustrating a case where a kinetic friction force applied to a fingertip varies when a natural vibration in an ultrasound-frequency-band is generated in the top panel of the tactile sensation providing apparatus;

FIG. 5B is a diagram illustrating a case where the kinetic friction force applied to the fingertip varies when the natural vibration in the ultrasound-frequency-band is generated in the top panel of the tactile sensation providing apparatus;

FIG. 6 is a diagram illustrating a configuration of tactile sensation providing apparatus according to the first embodiment;

FIG. 7A is a diagram illustrating data stored in a memory;

FIG. 7B is a diagram illustrating data stored in the memory;

FIG. 8A is a diagram illustrating driving patterns of a vibrating element in a case where a user performs a manipulation input on the tactile sensation providing apparatus of the first embodiment;

FIG. 8B is a diagram illustrating the driving patterns of the vibrating element in the case where the user performs the manipulation input on the tactile sensation providing apparatus of the first embodiment;

FIG. 9 is a diagram illustrating a flowchart executed by a drive controlling part of the tactile sensation providing apparatus according to the first embodiment;

FIG. 10 is a diagram illustrating procedures until the user of the tactile sensation providing apparatus of the first embodiment obtains tactile sensation data;

FIG. 11 is a diagram illustrating procedures until the user of the tactile sensation providing apparatus of the first embodiment obtains the tactile sensation data;

FIG. 12 is a diagram illustrating procedures when accessing a server from a smartphone terminal to create the tactile sensation data;

FIG. 13 is a diagram illustrating an environment where tactile sensation data of various users can be uploaded on the server and can be freely downloaded;

FIG. 14 is a diagram illustrating a tactile sensation providing apparatus according to a first variation example of the first embodiment;

FIG. 15 is a diagram illustrating a tactile sensation providing apparatus according to a second variation example of the first embodiment;

FIG. 16 is a diagram illustrating a tactile sensation providing apparatus according to a third variation example of the first embodiment;

FIG. 17 is a diagram illustrating an operating state of a tactile sensation providing apparatus of a fourth variation example according to the first embodiment;

FIG. 18 is a diagram illustrating procedures until the user of a tactile sensation providing apparatus of a second embodiment obtains the tactile sensation data;

FIG. 19 is a diagram illustrating the tactile sensation providing apparatus of the second embodiment in plan view;

FIG. 20 is a diagram illustrating a cross-sectional view of the tactile sensation providing apparatus taken along a line A-A of FIG. 19; and

FIG. 21 is a diagram illustrating a tactile sensation providing apparatus according to a variation example of the second embodiment.

### DESCRIPTION OF EMBODIMENT

Hereinafter, embodiments to which a tactile sensation providing apparatus and a system of the present invention are applied will be described.

### First Embodiment

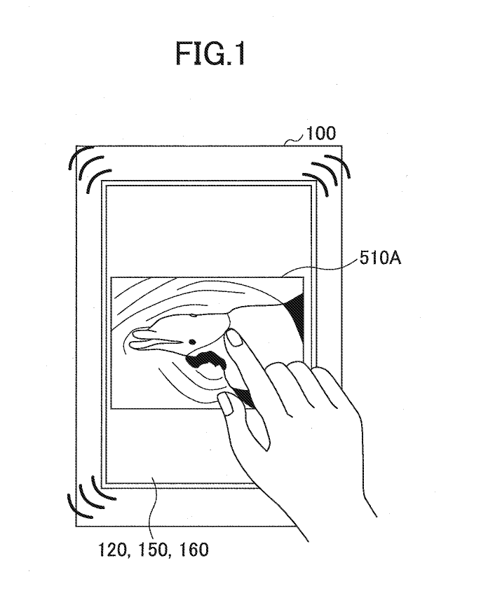

FIG. 1 is a diagram illustrating an example of a mode of using a tactile sensation providing apparatus 100 according to a first embodiment.

The tactile sensation providing apparatus 100 includes a top panel 120, a touch panel 150, and a display panel 160. The display panel 160 displays an image 510A of a dolphin.

It is not easy to directly touch an actual dolphin. However, when the user touches the top panel 120, disposed on a front face of the touch panel of the tactile sensation providing apparatus 100, to trace the image 510A displayed on the display panel 160, the tactile sensation providing apparatus 100 vibrates to provide tactile sensations as if the user were touching the surface of the dolphin with the fingertip. The dolphin is an example of a target tangible object.

In this way, even when the user does not touch an actual object, the tactile sensation providing apparatus 100 of the first embodiment provides simulated tactile sensations as if the user were touching the actual object when the user touches the touch panel 120.

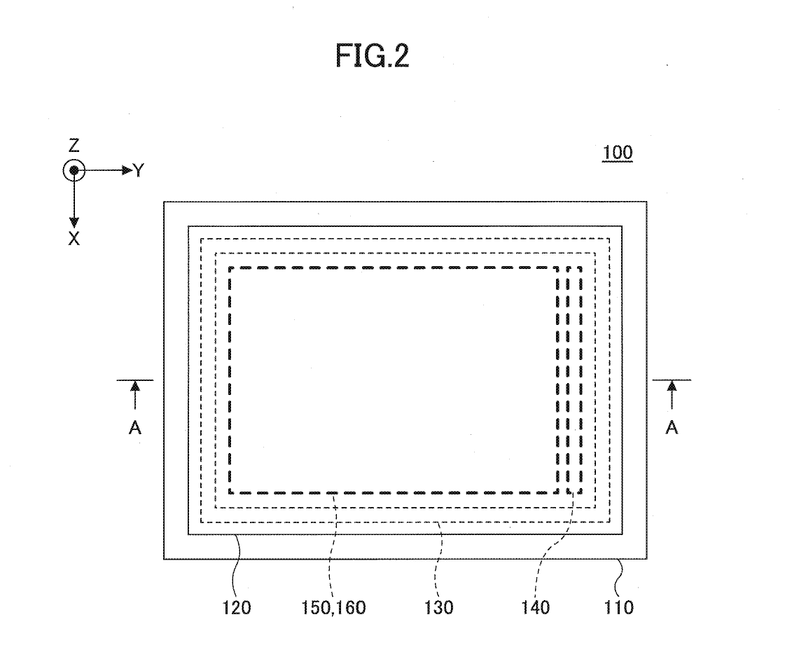

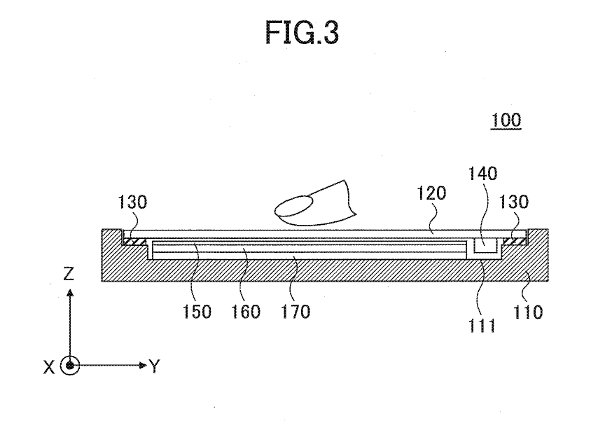

FIG. 2 is a diagram illustrating the tactile sensation providing apparatus 100 of the first embodiment in plan view. FIG. 3 is a diagram illustrating a cross-sectional view of the tactile sensation providing apparatus 100 taken along a line A-A of FIG. 2. A XYZ coordinate system as an orthogonal coordinate system is defined as illustrated in FIGS. 2 and 3.

The tactile sensation providing apparatus 100 includes a housing 110, the top panel 120, a double-faced adhesive tape 130, a vibrating element 140, the touch panel 150, the display panel 160, and a substrate 170.

The housing 110 is made of a plastic, for example. As illustrated in FIG. 3, the substrate 170, the display panel 160, and the touch panel 150 are contained in a concave portion 111 of the housing 110, and the top panel 120 is adhered to the housing 110 by the double-faced adhesive tape 130.

The top panel 120 is a plate-shaped member having a rectangular shape in plan view and is made of a transparent glass or a reinforced plastic such as polycarbonate. A surface of the top panel 120 which is located on a positive side in Z axis direction is one example of a manipulation input surface into which the user of the tactile sensation providing apparatus 100 performs a manipulation input.

The vibrating element 140 is bonded on a surface of the top panel 120 which is located on a negative side in Z axis direction, and four sides in plan view of the top panel 120 are adhered to the housing 110 by the double-faced adhesive tape 130. Herein, the double-faced adhesive tape 130 is not necessarily a rectangular-ring-shaped member in plan view as illustrated in FIG. 3, as long as the double-faced adhesive tape 130 can adhere four sides of the top panel 120 to the housing 110.

The touch panel 150 is disposed on the negative side in Z axis direction of the top panel 120. The top panel 120 is provided in order to protect the surface of the touch panel 150. Another panel, protection film or the like may be provided on the surface of the top panel 120.

In a state where the vibrating element 140 is bonded to the surface of the top panel 120 located on the negative side in Z axis direction, the top panel 120 vibrates if the vibrating element 140 is being driven. In the first embodiment, a standing wave is generated in the top panel 120 by causing the top panel 120 to vibrate at a natural vibration frequency (natural resonance frequency or eigenfrequency) of the top panel 120. Because the vibrating element 140 is bonded to the top panel 120, it is preferable to determine the natural vibration frequency in consideration of a weight of the vibrating element 140 of the like, in a practical manner.

The vibrating element 140 is bonded on the surface of the top panel 120 which is located on the negative side in Z axis direction at a location along the short side extending in X axis direction at a positive side in Y axis direction. The vibrating element 140 may be any element as long as it can generate vibration in an ultrasound-frequency-band. A piezoelectric element such as a piezo element is used as the vibrating element 140, for example.

The vibrating element 140 is driven in accordance with a driving signal output from a drive controlling part which will be described later. An amplitude (intensity) and a frequency of the vibration output from the vibrating element 140 is set by the driving signal. An on/off action of the vibrating element 140 is controlled in accordance with the driving signal.

The ultrasound-frequency-band is a frequency band which is higher than or equal to about 20 kHz, for example. According to the tactile sensation providing apparatus 100 of the embodiment, the frequency at which the vibrating element 140 vibrates is equal to a number of vibrations per unit time (frequency) of the top panel 120. Accordingly, the vibrating element 140 is driven in accordance with the driving signal so that the vibrating element 140 vibrates at a number of natural vibrations per unit time (natural vibration frequency) of the top panel 120.

The touch panel 150 is disposed on an upper side (positive side in Z axis direction) of the display panel 160 and is disposed on a lower side (negative side in Z axis direction) of the top panel 120. The touch panel 150 is one example of a coordinate detector which detects a position at which the user of the tactile sensation providing apparatus 100 touches the top panel 120. Hereinafter, the position is referred to as a position of the manipulation input.

The display panel 160 disposed under the touch panel 150 displays various GUI buttons or the like (hereinafter referred to as Graphic User Interface (GUI) input part(s) 102). The user of the tactile sensation providing apparatus 100 ordinarily touches the top panel 120 with a fingertip in order to manipulate (operate) the GUI input part.

The touch panel 150 is any coordinate detector as long as it can detect the position of the manipulation input onto the top panel 120 performed by the user. The touch panel 150 may be a capacitance type coordinate detector or a resistance film type coordinate detector, for example. Hereinafter, the embodiment in which the touch panel 150 is the capacitance type coordinate detector will be described. In a case where the touch panel 150 is a capacitance type, the touch panel 150 can detect the manipulation input performed on the top panel 120 even if there is a clearance gap between the touch panel 150 and the top panel 120.

Although the top panel 120 is disposed on the manipulation input surface side of the touch panel 150 in the present embodiment, the top panel 120 may be integrated with the touch panel 150. In this case, the surface of the touch panel 150 is equal to the surface of the top panel 120 as illustrated in FIGS. 2 and 3, and the surface of the touch panel 150 becomes the manipulation input surface. Otherwise, the top panel 120 as illustrated in FIGS. 2 and 3 may be omitted. In this case, the surface of the touch panel 150 constitutes the manipulation input surface. In this case, the vibrating element 140 vibrates the manipulation input surface at a natural vibration frequency of a member having the manipulation input surface.

In a case where the touch panel 150 is a capacitance type, the touch panel 150 may be disposed on the top panel 120. In this case, the surface of the touch panel 150 constitutes the manipulation input surface. In a case where the touch panel 150 is a capacitance type, the top panel 120 as illustrated in FIGS. 2 and 3 may be omitted. In this case, the surface of the touch panel 150 constitutes the manipulation input surface. In this case, the vibrating element 140 vibrates the manipulation input surface at a natural vibration frequency of a member having the manipulation input surface.

The display panel 160 is a display part which displays an image. The display panel 160 may be a liquid crystal display panel, an organic Electroluminescence (EL) panel or the like, for example. The display panel 160 is disposed in the concave portion 111 of the housing 110 and is disposed on (the positive side in Z axis direction of) the substrate 170.

The display panel 160 is driven and controlled by a driver Integrated Circuit (IC) and displays the GUI input part, the image, characters, symbols, graphics or the like in accordance with an operating state of the tactile sensation providing apparatus 100.

The substrate 170 is disposed in the concave portion 111 of the housing 110. The display panel 160 and the touch panel 150 are disposed on the substrate 170. The display panel 160 and the touch panel 150 are fixed to the substrate 170 and the housing 110 by a holder or the like (not shown).

On the substrate 170, a drive controlling apparatus which will be described hereinafter and circuits or the like that are necessary for driving the tactile sensation providing apparatus 100 are mounted.

In the tactile sensation providing apparatus 100 having the configuration as described above, when the user touches the top panel 120 with the fingertip and a movement of the fingertip is detected, the drive controlling part mounted on the substrate 170 drives the vibrating element 140 so that the top panel 120 vibrates at a frequency in the ultrasound-frequency-band. The frequency in the ultrasound-frequency-band is a resonance frequency of a resonance system including the top panel 120 and the vibrating element 140. A standing wave is generated in the top panel 120 at the frequency.

The tactile sensation providing apparatus 100 generates the standing wave in the ultrasound-frequency-band in the top panel 120 to provide a tactile sensation (haptic sensation) to the user through the top panel 120.

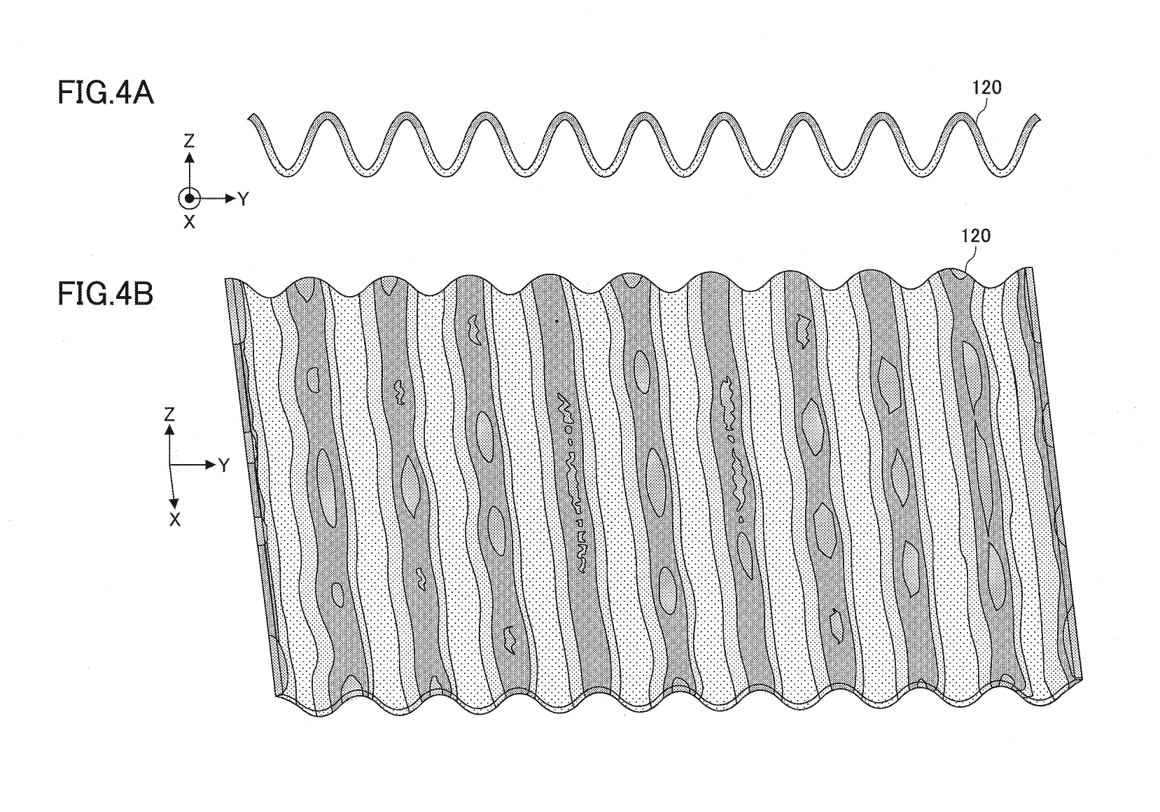

Next, the standing wave generated in the top panel 120 is described with reference to FIGS. 4A and 4B.

FIGS. 4A and 4B are diagrams illustrating crests and troughs of the standing wave formed in parallel with the short side of the top panel 120 included in the standing waves generated in the top panel 120 by the natural vibration in the ultrasound-frequency-band. FIG. 4A illustrates a side view, and FIG. 4B illustrates a perspective view. In FIGS. 4A and 4B, a XYZ coordinate system similar to that described in FIGS. 2 and 3 is defined. In FIGS. 4A and 4B, the amplitude of the standing wave is overdrawn in an easy-to-understand manner. The vibrating element 140 is omitted in FIGS. 4A and 4B.

The natural vibration frequency (the resonance frequency) f of the top panel 120 is represented by formulas (1) and (2) where E is the Young's modulus of the top panel 120, ρ is the density of the top panel 120, δ is the Poisson's ratio of the top panel 120, l is the long side dimension of the top panel 120, t is the thickness of the top panel 120, and k is a periodic number of the standing wave along the direction of the long side of the top panel 120. Because the standing wave has the same waveforms in every half cycle, the periodic number k takes values at 0.5 intervals. The periodic number k takes 0.5, 1, 1.5, 2 . . . .

$$\begin{matrix}f = \frac{π {k}^{2} t}{{l}^{2}} \sqrt{\frac{E}{3 ρ ( 1 - {δ}^{2} )}} & ( 1 ) \\ f = α {k}^{2} & ( 2 )\end{matrix}$$

The coefficient α included in formula (2) corresponds to coefficients other than k² included in formula (1).

A waveform of the standing wave as illustrated FIGS. 4A and 4B is obtained in a case where the periodic number k is 10, for example. In a case where a sheet of Gorilla (registered trademark) glass of which the length 1 of the long side is 140 mm, the length of the short side is 80 mm, and the thickness t is 0.7 mm is used as the top panel 120, for example, the natural vibration number f is 33.5 kHz, if the periodic number k is 10. In this case, a frequency of the driving signal is 33.5 kHz.

The top panel 120 is a planar member. If the vibrating element 140 (see FIGS. 2 and 3) is driven and the natural vibration in the ultrasound-frequency-band is generated in the top panel 120, the top panel 120 is bent as illustrated in FIGS. 4A and 4B. As a result, the standing wave is generated in the surface of the top panel 120.

In the present embodiment, the single vibrating element 140 is bonded on the surface of the top panel 120 which is located on the negative side in Z axis direction at the location along the short side extending in X axis direction at the positive side in Y axis direction. The tactile sensation providing apparatus 100 may include two vibrating elements 140. In a case where the tactile sensation providing apparatus 100 includes two vibrating elements 140, another vibrating element 140 may be bonded on the surface of the top panel 120 which is located on the negative side in Z axis direction at a location along the short side extending in X axis direction at a negative side in Y axis direction. In this case, the two vibrating elements 140 may be axisymmetrically disposed with respect to a center line of the top panel 120 parallel to the two short sides of the top panel 120.

In a case where the tactile sensation providing apparatus 100 includes two vibrating elements 140, the two vibrating elements 140 may be driven in the same phase, if the periodic number k is an integer number. If the periodic number k is an odd number, the two vibrating elements 140 may be driven in opposite phases.

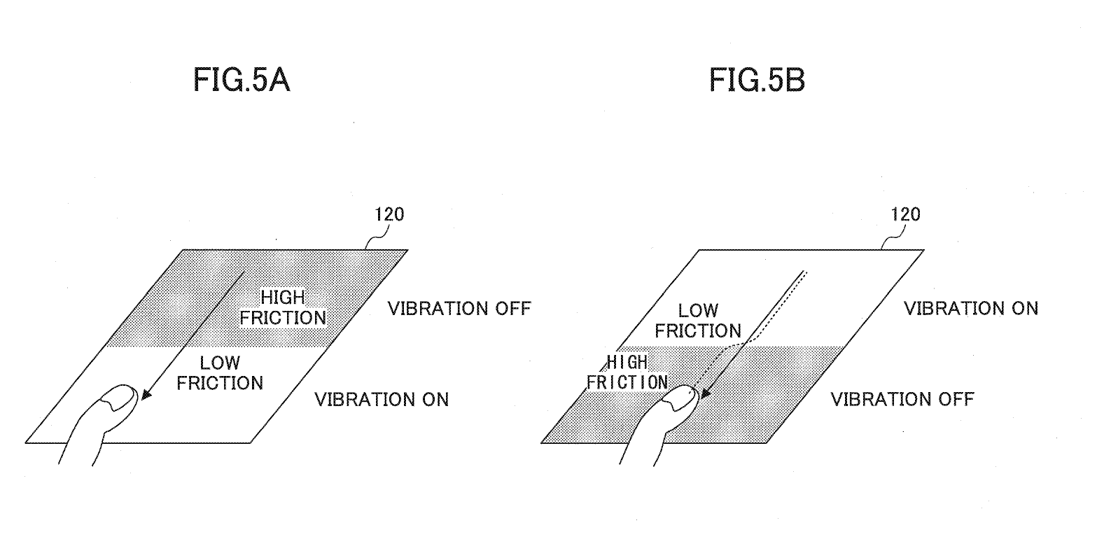

Next, the natural vibration at ultrasound-frequency-band generated in the top panel 120 of the tactile sensation providing apparatus 100 is described with reference to FIGS. 5A and 5B.

FIGS. 5A and 5B are diagrams illustrating cases where a kinetic friction force applied to the fingertip varies when the natural vibration in the ultrasound-frequency-band is generated in the top panel 120 of the tactile sensation providing apparatus 100. In FIGS. 5A and 5B, the manipulation input is performed with the fingertip. In FIGS. 5A and 5B, the user touches the top panel 120 with the fingertip and performs the manipulation input by tracing the top panel 120 with the fingertip in a direction from a far side to a near side with respect to the user. An on/off state of the vibration is switched by controlling an on/off state of the vibrating element 140 (see FIGS. 2 and 3).

In FIGS. 5A and 5B, areas which the fingertip touches while the vibration is turned off are indicated in grey in the depth direction of the top panel 120. Areas which the fingertip touches while the vibration is turned on are indicated in white in the depth direction of the top panel 120.

As illustrated in FIGS. 4A and 4B, the natural vibration in the ultrasound-frequency-band occurs on an entire surface of the top panel 120. FIGS. 5A and 5B illustrate operation patterns in which the on/off state of the natural vibration is switched while the user's fingertip is tracing the top panel 120 from the far side to the near side.

Accordingly, in FIGS. 5A and 5B, areas which the fingertip touches while the vibration is turned off are indicated in grey in the depth direction of the top panel 120. Areas which the fingertip touches while the vibration is turned on are indicated in white in the depth direction of the top panel 120.

In the operation pattern as illustrated in FIG. 5A, the vibration is turned off when the user's fingertip is located on the far side of the top panel 120, and the vibration is turned on in the process of tracing the top panel 120 with the fingertip toward the near side.

On the contrary, in the operation pattern as illustrated in FIG. 5B, the vibration is turned on when the user's fingertip is located on the far side of the top panel 120, and the vibration is turned off in the process of tracing the top panel 120 with the fingertip toward the near side.

In a state where the natural vibration in the ultrasound-frequency-band is generated in the top panel 120, a layer of air intervenes between the surface of the top panel 120 and the fingertip. The layer of air is provided by a squeeze film effect. As a result, a kinetic friction coefficient on the surface of the top panel 120 is decreased when the user traces the surface with the fingertip.

Accordingly, in the grey area located on the far side of the top panel 120 as illustrated in FIG. 5A, the kinetic friction force applied to the fingertip increases. In the white area located on the near side of the top panel 120, the kinetic friction force applied to the fingertip decreases.

Therefore, the user who is performing the manipulation input to the top panel 120 in a manner as illustrated in FIG. 5A senses a reduction of the kinetic friction force applied to the fingertip when the vibration is turned on. As a result, the user senses a slippery or smooth touch (texture) with the fingertip. In this case, the user senses as if a concave portion were present on the surface of the top panel 120 when the surface of the top panel 120 becomes slippery and the kinetic friction force decreases.

On the contrary, in the white area located on the far side of the top panel 120 as illustrated in FIG. 5B, the kinetic friction force applied to the fingertip decreases. In the grey area located on the near side of the top panel 120, the kinetic friction force applied to the fingertip increases.

Therefore, the user who is performing the manipulation input in the top panel 120 in a manner as illustrated in FIG. 5B senses an increase of the kinetic friction force applied to the fingertip when the vibration is turned off. As a result, the user senses a grippy or scratchy touch (texture) with the fingertip. In this case, the user senses as if a convex portion were present on the surface of the top panel 120 when the surface of the top panel 120 becomes grippy and the kinetic friction force increases.

Accordingly, the user can sense a concavity or convexity with the fingertip in the cases as illustrated in FIGS. 5A and 5B. For example, “The Printed-matter Typecasting Method for Haptic Feel Design and Sticky-band Illusion” (the Collection of papers of the 11th SICE system integration division annual conference (SI2010, Sendai)_174-177, 2010-12) discloses that a human can sense a concavity or a convexity. “Fishbone Tactile Illusion” (Collection of papers of the 10th Congress of the Virtual Reality Society of Japan (September, 2005)) discloses that a human can sense a concavity or a convexity as well.

Although a variation of the kinetic friction force when the vibration is switched on or off is described above, a variation of the kinetic friction force similar to those described above is obtained when the amplitude (intensity) of the vibrating element 140 is varied.

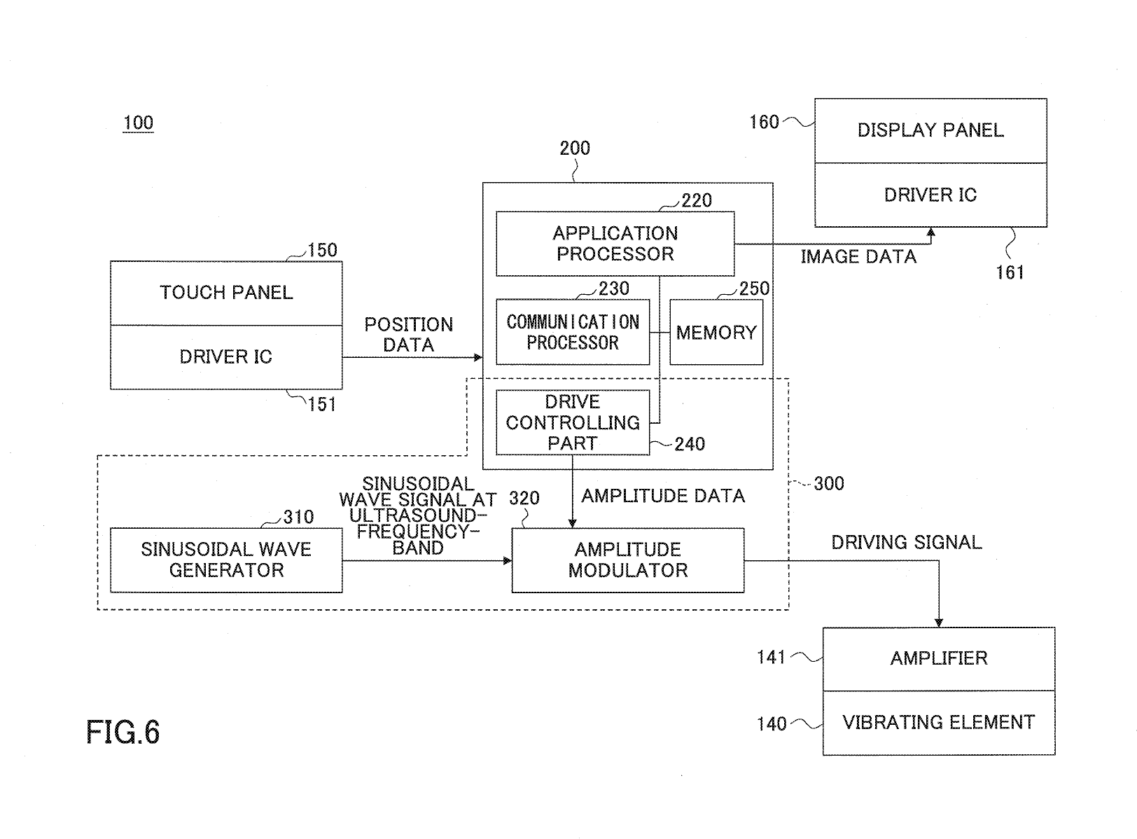

In the following, a configuration of the tactile sensation providing apparatus 100 according to the first embodiment is described with reference to FIG. 6.

FIG. 6 is a diagram illustrating the configuration of the tactile sensation providing apparatus 100 according to the first embodiment.

The tactile sensation providing apparatus 100 includes the vibrating element 140, an amplifier 141, the touch panel 150, a driver Integrated Circuit (IC) 151, the display panel 160, a driver IC 161, a controller 200, a sinusoidal wave generator 310, and a amplitude modulator 320.

The controller 200 includes an application processor 220, a drive controlling part 240, and a memory 250. The controller 200 is realized by an IC chip, for example.

The drive controlling part 240, the sinusoidal wave generator 310, and the amplitude modulator 320 constitute a drive controlling apparatus 300. Although an embodiment in which the application processor 220, the drive controlling part 240 and the memory 250 are included in the single controller 200 is described, the drive controlling part 240 may be disposed outside of the controller 200 and realized by another IC chip or a processor. In this case, data which is necessary for a drive control performed by the drive controlling part 240 among data stored in the memory 250 may be stored in another memory disposed in the drive control apparatus 300.

In FIG. 6, the housing 110, the top panel 120, the double-faced adhesive tape 130, and the substrate 170 (see FIG. 2) are omitted. Herein, the amplifier 141, the driver IC 151, the driver IC 161, the drive controlling part 240, the memory 250, the sinusoidal wave generator 310 and the amplitude modulator 320 are described.

The amplifier 141 is disposed between the drive controlling apparatus 300 and the vibrating element 140. The amplifier 141 amplifies the driving signal output from the drive controlling apparatus 300 and drives the vibrating element 140.

The driver IC 151 is connected to the touch panel 150. The driver IC 151 detects position data representing the position on the touch panel 150 at which the manipulation input is performed and outputs the position data to the controller 200. As a result, the position data is input to the application processor 220 and the drive controlling part 240. Inputting the position data to the drive controlling part 240 is equal to inputting the position data to the drive controlling apparatus 300.

The driver IC 161 is connected to the display panel 160. The driver IC 161 inputs image data output from the drive controlling apparatus 300 to the display panel 160 and displays a picture image on the display panel 160 based on the image data. Accordingly, the GUI input part, the picture image or the like is displayed on the display panel 160 based on the image data.

The application processor 220 outputs image data that represents GUI input parts, images, characters, symbols, figures, or the like to the driver IC 161. The image data is required for the user to manipulate the tactile sensation providing apparatus 100.

The communication processor 230 performs processes that are necessary for the tactile sensation providing apparatus 100 to perform communications such as WiFi, Bluetooth (registered trademark), non-contact short distance communication, or the like. In a case where the tactile sensation providing apparatus 100 does not have to perform the communication, the tactile sensation providing apparatus 100 does not have to include the communication processor 230.

The drive controlling part 240 outputs amplitude data, representing an amplitude, to the amplitude modulator 320. The amplitude data represents an amplitude value used for adjusting an intensity of the driving signal used for driving the vibrating element 140. The amplitude data representing the amplitude may be stored in the memory 250.

The tactile sensation providing apparatus 100 of the first embodiment causes the top panel 120 to vibrate in order to vary the kinetic friction force applied to the user's fingertip when the fingertip traces along the surface of the top panel 120.

There are various manipulation inputs such as a flick operation, a swipe operation and a drag operation, for example, that the user performs when the user moves the fingertip along the surface of the top panel 120.

The flick operation is performed by flicking (snapping) the surface of the top panel 120 for a relatively-short distance with the fingertip. The swipe operation is performed by swiping the surface of the top panel 120 for a relatively-long distance with the fingertip. The drag operation is performed by moving the fingertip along the surface of the top panel 120 while selecting a button or the like displayed on the display panel 160 when the user slides the button of the like.

The manipulation inputs that are performed by moving the fingertip along the surface of the top panel 120, such as the flick operation, the swipe operation and the drag operation that are introduced as examples, are used differently depending on a kind of the GUI input part of the like displayed on the display panel 160.

In addition to the above described processes, the drive controlling part 240 may set the amplitude value in accordance with a temporal change degree of the position data.

Here, a moving speed of the user's fingertip tracing along the surface of the top panel 120 is used as the temporal change degree of the position data. The drive controlling part 240 may calculate the moving speed of the user's fingertip based on a temporal change degree of the position data input from the driver IC 151.

The higher the moving speed becomes, the smaller the tactile sensation providing apparatus 100 controls the amplitude value to be, for the sake of making an intensity of the tactile sensation sensed by the user constant regardless of the moving speed of the fingertip, for example. The lower the moving speed becomes, the greater the tactile sensation providing apparatus 100 controls the amplitude value to be, for the sake of making the intensity constant regardless of the moving speed of the fingertip, for example.

Data which represents a relationship between the amplitude data, representing the amplitude value, and the moving speed may be stored in the memory 250.

Although the amplitude value in accordance with the moving speed is set by using the data that represents the relationship between the amplitude data, representing the amplitude value, and the moving speed in the present embodiment, the amplitude value A may be calculated based on formula (3). The higher the moving speed becomes, the smaller the amplitude value A calculated by formula (3) becomes. The lower the moving speed becomes, the greater the amplitude value A calculated by formula (3) becomes.

A=A₀/\sqrt{|V|/a} (3)

“A₀” is a reference value of the amplitude, “V” represents the moving speed of the fingertip and “a” is a designated constant value. In a case where the amplitude value A is calculated by using formula (3), data representing formula (3) and data representing the reference value A₀ and the designated constant value a may be stored in the memory 250.

The drive controlling part 240 causes the vibrating element 140 to vibrate when the moving speed becomes greater than or equal to a designated threshold speed.

Accordingly, the amplitude value represented by the amplitude data output from the drive controlling part 240 becomes zero in a case where the moving speed is less than the designated threshold speed. The amplitude value is set to a designated amplitude value corresponding to the moving speed in a case where the moving speed is greater than or equal to the designated threshold speed. In a case where the moving speed is greater than or equal to the designated threshold speed, the higher the moving speed becomes, the smaller the amplitude value becomes. In a case where the moving speed is greater than or equal to the designated threshold speed, the lower the moving speed becomes, the greater the amplitude value becomes.

The memory 250 stores data that associates coordinate data with pattern data. The coordinate data represents the GUI input part or the like to which the manipulation input is performed. The pattern data represents the amplitude data.

The sinusoidal wave generator 310 generates sinusoidal waves used for generating the driving signal which causes the top panel 120 to vibrate at the natural vibration frequency. For example, in a case of causing the top panel 120 to vibrate at 33.5 kHz of the natural vibration frequency f, a frequency of the sinusoidal waves becomes 33.5 kHz. The sinusoidal wave generator 310 inputs a sinusoidal wave signal in the ultrasound-frequency-band to the amplitude modulator 320.

The amplitude modulator 320 generates the driving signal by modulating an amplitude of the sinusoidal wave signal input from the sinusoidal wave generator 310 based on the amplitude data input from the drive controlling part 240. In the basic operation, the amplitude modulator 320 modulates the amplitude of the sinusoidal wave signal in the ultrasound-frequency-band input from the sinusoidal wave generator 310 and does not modulate a frequency and a phase of the sinusoidal wave signal in order to generate the driving signal.

Therefore, the driving signal output from the amplitude modulator 320 is a sinusoidal wave signal in the ultrasound-frequency-band obtained by modulating only the amplitude of the sinusoidal wave signal in the ultrasound-frequency-band input from the sinusoidal wave generator 310. In a case where the amplitude data is zero, the amplitude of the driving signal becomes zero. This is the same as the amplitude modulator 320 not outputting the driving signal.

The amplitude modulator 320 can modulate the sinusoidal wave signal in the ultrasound-frequency-band input from the sinusoidal wave generator 310 by using a sinusoidal wave signal in an audible frequency band. In this case, a driving signal output from the amplitude modulator 320 becomes a signal in which a driving signal in the audible frequency band is superimposed on a driving signal in the ultrasound-frequency-band and an amplitude of the signal is set by the amplitude modulator 320.

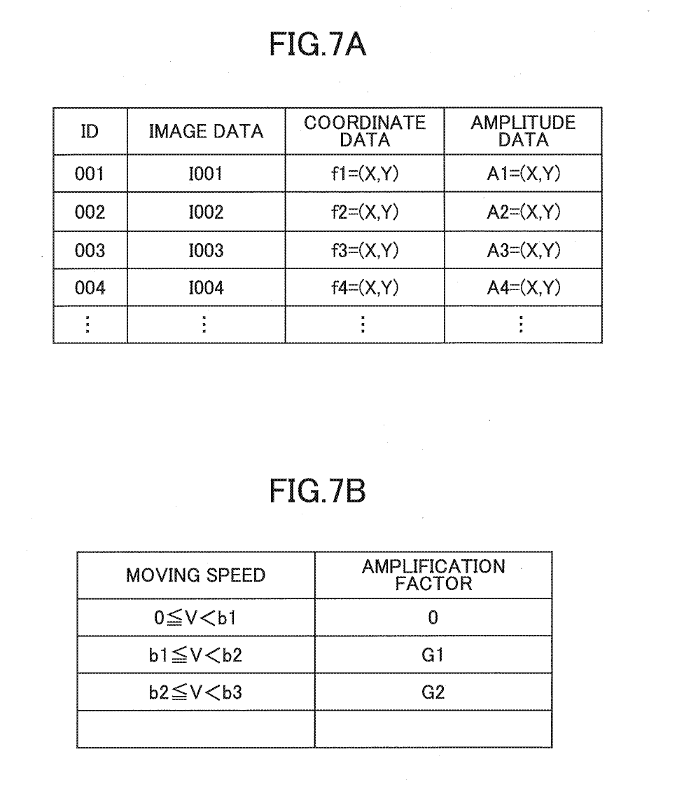

In the following, the data stored in the memory 250 is described with reference to FIGS. 7A and 7B.

FIGS. 7A and 7B are diagrams illustrating the data stored in the memory 250.

The data illustrated in FIG. 7A is tactile sensation data that associates image data, coordinate data, and amplitude data with ID (IDentification).

The ID is an identifier of the tactile sensation data. In FIG. 7A, 001, 002, 003, 004 and the like are illustrated as an example of the ID.

The image data represents an image of a target tangible object such as the image 510A of the dolphin illustrated in FIG. 1. In FIG. 7A, I001, I002, I003, I004 and the like of the image data are illustrated.

The coordinate data represents coordinates of the image in the image data. For example, coordinates may be allocated to each pixel. A constant number of pixels may be allocated to each unit area as single unit area. In FIG. 7A, f1 to f4 of the coordinate data are illustrated.

The amplitude data represents amplitude values for adjusting an intensity of the driving signal used to drive the vibrating element 140. The amplitude data is allocated to the area represented by each coordinate data. In FIG. 7A, A1 (X,Y), A2 (X,Y), A3 (X,Y), and A4 (X,Y) of the amplitude data are illustrated.

For example, a shape, convex portions, concave portions, and the like of a surface of an actual target tangible object are measured by 3D scanning or the like. The amplitude values of the amplitude data allocated to the area represented by each coordinate data may be set as amplitude values in accordance with the measured value such that the user can sense the shape, the convex portions, the concave portions, and the like of the target tangible object with the fingertip based on the natural vibrations in the ultrasound-frequency-band of the top panel 120.

The data illustrated in FIG. 7B associates amplification factor data, representing an amplification factor of the amplitude value, with the moving speed. According to the data as illustrated in FIG. 7B, the amplification factor is set to 0 in a case where the moving speed V is greater than or equal to 0 and less than b1 (0<=V<b1), the amplification factor is set to G1 in a case where the moving speed V is greater than or equal to b1 and less than b2 (b1<=V<b2), and the amplification factor is set to G2 in a case where the moving speed V is greater than or equal to b2 and less than b3 (b2<=V<b3).

For example, in order to make the tactile sensation sensed by the user's fingertip constant regardless of the moving speed of the fingertip, a lower amplitude value is set as the moving speed increases by using the amplification factor data illustrated in FIG. 7B, and a higher amplitude value is set as the moving speed decreases by using the amplification factor.

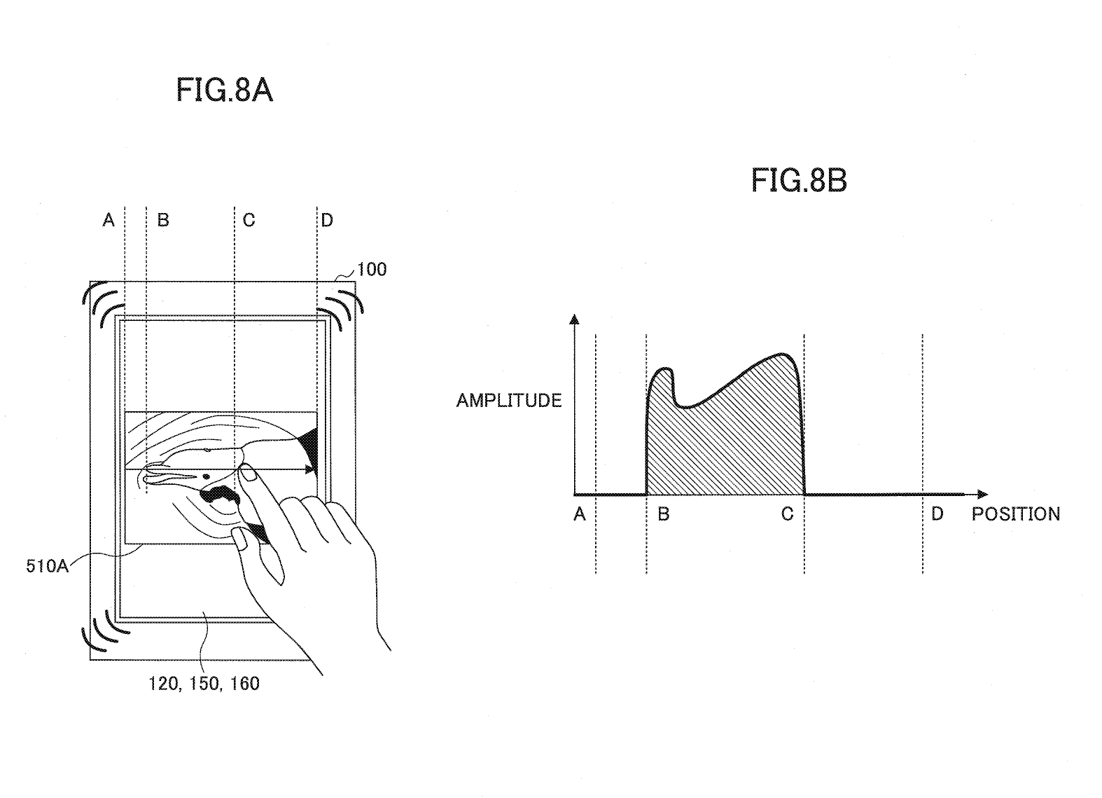

FIGS. 8A and 8B are diagrams illustrating driving patterns of the vibrating element 140 in a case where the user performs the manipulation input on the tactile sensation providing apparatus 100 of the first embodiment.

FIG. 8A illustrates a situation where the user's fingertip touches the top panel 120 of the tactile sensation providing apparatus 100 and traces the image 510A being displayed on the display panel 160.

In FIG. 8B, a lateral axis indicates a position of the user's fingertip in the tracing direction of the image 510A in FIG. 8A, and a vertical axis indicates an amplitude of the driving signal. Points A to D are illustrated in the lateral direction. FIG. 8B illustrates an example of driving patterns in a case where the user's fingertip traces the image 510A.

In FIGS. 8A and 8B, the manipulation input starts from the point A. However, because the point A is outside of an area of the image 510A that represents the dolphin, the drive controlling part 240 does not drive the vibrating element 140 at this point of time. Therefore, the amplitude is zero.

When the user's fingertip moves and reaches the point B, the drive controlling part 240 drives the vibrating element 140 based on the tactile sensation data because the point B is inside of the area of the image 510A that represents the dolphin. Because the tactile sensation data includes the coordinate data and the amplitude data as illustrated in FIG. 7A, the drive controlling part 240 outputs the amplitude data corresponding to the position data input from the driver IC 151.

When the position of the manipulation input moves to the point C from the point B, the drive controlling part 240 drives the vibrating element 140 in response to the driving patterns so that the amplitude exponentially increases at the point B; after that, the amplitude decreases; after that, the amplitude increases toward the point C; and after that, the amplitude decreases immediately before the point C.

Such driving patterns between the point B and the point C provide the tactile sensations to the fingertip as if the kinetic friction force applied to the fingertip exponentially decreases from the point B; after that, the kinetic friction force increases in accordance with decrease of the amplitude; after that, the kinetic friction force decreases again in accordance with increasing of the amplitude toward the point C; and after that, the kinetic friction force increases immediately before the point C in accordance with decreasing of the amplitude.

Such tactile sensations reproduce slippery tactile sensations that a human senses with the fingertip when the human touches a surface of an actual dolphin.

When the position of the user's fingertip passes the point C, the drive controlling part 240 stops the vibrating element 140 because the point C is outside of the area of the image 510A that represents the dolphin. Therefore, between the point C and the point D, the amplitude is zero.

Such driving patterns represent a driving signal that changes the amplitude based on the amplitude data at a frequency of 35 kHz.

When the position of the manipulation input reaches the display area of the image 510A, the vibrating element 140 is turned on. As a result, the kinetic friction coefficient applied to the user's fingertip is decreased by the squeeze film effect and the fingertip becomes easy to move over the surface of the top panel 120.

When the position of the manipulation input comes out of the display area of the image 510A, the drive controlling part 240 turns the vibrating element 140 off. The drive controlling part 240 may turn the vibrating element 140 off by setting the amplitude to zero.

When the vibrating element 140 is turned off, the natural vibration in the ultrasound-frequency-band of the top panel 120 is turned off. As a result, the kinetic friction force applied to the user's fingertip increases and the user senses a grippy or scratchy touch (texture) with the fingertip. In this case, the user senses as if a convex portion were present on the surface of the top panel 120 when the surface of the top panel 120 becomes grippy and the kinetic friction force increases.

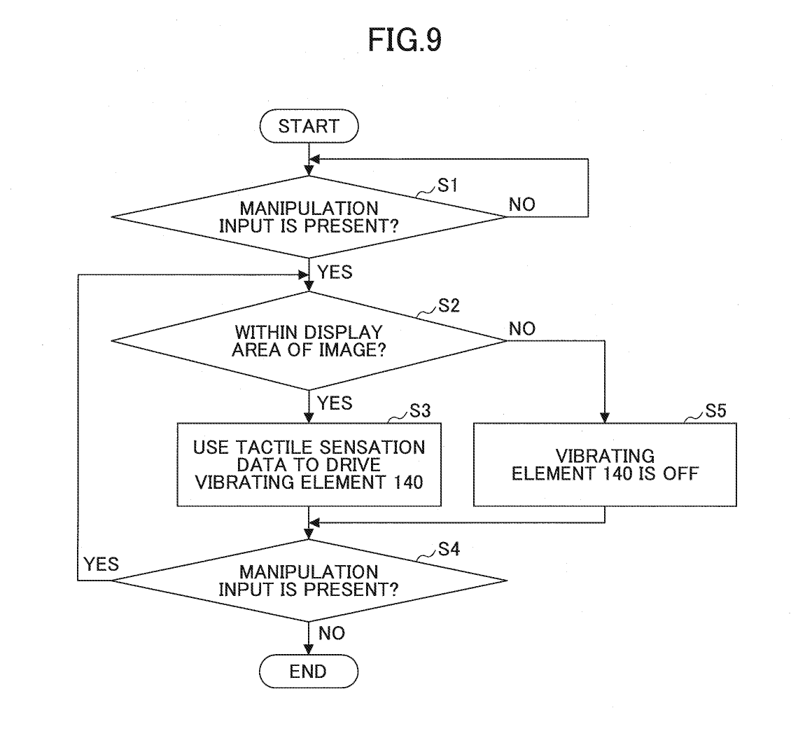

FIG. 9 is a diagram illustrating a flowchart executed by the drive controlling part 240 of the tactile sensation providing apparatus 100 according to the first embodiment.

First, the drive controlling part 240 determines whether the manipulation input is present (step S1). The drive controlling part 240 may determine presence/absence of the manipulation input based on whether the position data is input from the driver IC 151 (see FIG. 6).

When the drive controlling part 240 determines that the manipulation input is present (yes at step S1), the drive controlling part 240 determines whether a position of the manipulation input is within the display area of the image 510A (step S2). This is because a driving state (on/off) of the vibrating element 140 varies depending on whether the position is within the display area of the image 510A.

When the drive controlling part 240 determines that the position of the manipulation input is within the display area of the image 510A (yes at step S2), the flow proceeds to step S3.

The drive controlling part 240 uses the tactile sensation data to drive the vibrating element 140 (step S3). The drive controlling part 240 extracts, from the tactile sensation data, the amplitude data corresponding to the position data input from the driver IC151, and outputs the amplitude data. In this way, the vibrating element 140 is driven based on the amplitude data.

Next, the drive controlling part 240 determines whether the manipulation input is present (step S4). The drive controlling part 240 may determine presence/absence of the manipulation input based on whether the position data is input from the driver IC 151 (see FIG. 6).

When the drive controlling part 240 determines that the manipulation input is present (yes at step S4), the flow returns to step S2.

In contrast, when the drive controlling part 240 determines that the manipulation input is not present (no at step S4), a series of processes ends (END). The drive controlling part 240 does not have to drive the vibrating element 140 in a case where the manipulation input is not present because the user does not perform the manipulation input in this case.

When the drive controlling part 240 determines that the position of the manipulation input is not within the display area of the image 510A (no at step S2), the flow proceeds to step S4. Presence/absence of the manipulation input is determined at step S4. When the manipulation input is present, the flow returns to step S2.

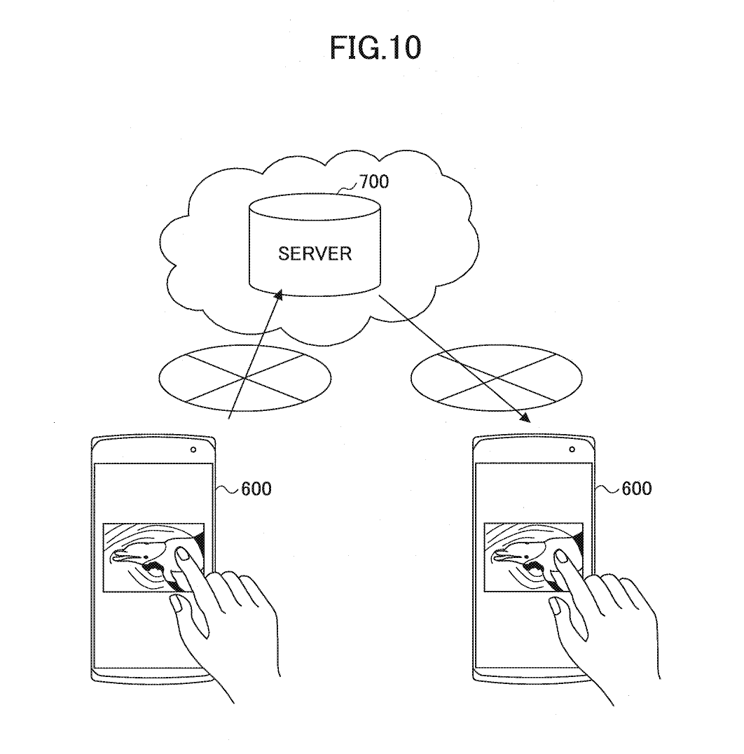

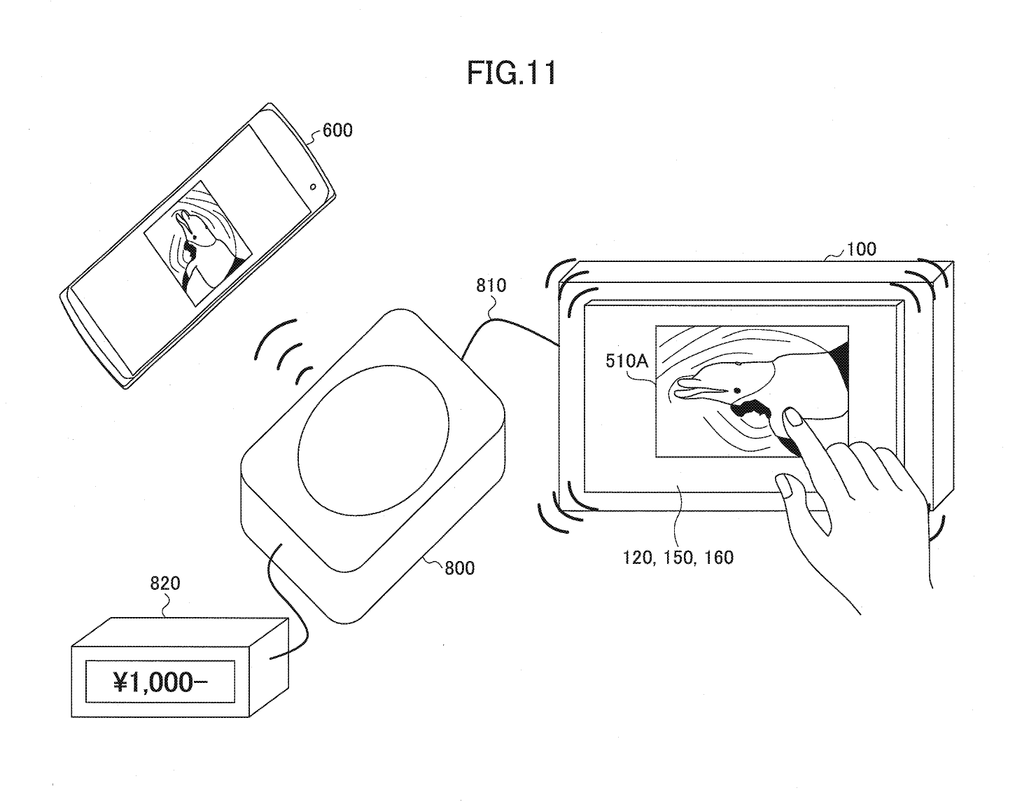

FIGS. 10 and 11 are diagrams that depict procedures until the user of the tactile sensation providing apparatus 100 of the first embodiment obtains the tactile sensation data.

First, as illustrated in FIG. 10, the user selects a photograph stored in a smartphone terminal 600 and transmits the photograph to a server 700 via a network. In the server 700, a service that gives tactile sensation information to an image is provided and the tactile sensation data (see FIG. 7A) is created.

The user downloads the tactile sensation data to the smartphone terminal 600 from the server 700 via the network and stores the tactile sensation data in an inner memory.

As illustrated in FIG. 11, the user holds the smartphone terminal 600 over a short distance wireless communication apparatus 800 to transmit favorite tactile sensation data to the short distance wireless communication apparatus 800 from the smartphone terminal 600.

The short distance wireless communication apparatus 800 can perform communication with the smartphone terminal 600 in a radio condition such as Bluetooth (registered trademark), for example. The short distance wireless communication apparatus 800 is connected to the tactile sensation providing apparatus 100 via a data cable 810.

In FIG. 11, the user transmits the tactile sensation data on the image 510A of the dolphin to the tactile sensation providing apparatus 100 via the short distance wireless communication apparatus 800, and the tactile sensation providing apparatus 100 displays the image 510A of the dolphin on the display panel 160. The short distance wireless communication apparatus 800 is an example of an input apparatus.

When the user traces the image 510A in this state, the tactile sensation providing apparatus 100 vibrates to provide the tactile sensations as if the user were touching the surface of the dolphin with the fingertip. When the tactile sensation providing apparatus 100 of the first embodiment is installed at a location where people gather such as a restaurant or a cafe for example, the user can feel the tactile sensations through the tactile sensation providing apparatus 100 as if the user were touching the surface of a dolphin.

In such a case, charging may be performed in accordance with a data communication amount between the smartphone terminal 600 and the short distance wireless communication apparatus 800, a number of times of use of the short distance wireless communication apparatus 800 or the tactile sensation providing apparatus 100, a utilization time of the short distance wireless communication apparatus 800 or the tactile sensation providing apparatus 100 or the like. Without using the short distance wireless communication apparatus 800, the wire communication via a direct cable or data transmission via a transportable recording medium such as a flash memory card can be performed between the tactile sensation providing apparatus 100 and the smartphone terminal 600. For example, a usage fee may be charged in accordance with a number of times of use of the short distance wireless communication apparatus 800, a utilization time of the short distance wireless communication apparatus 800, or the like by connecting the short distance wireless communication apparatus 800 to a charging apparatus 820.

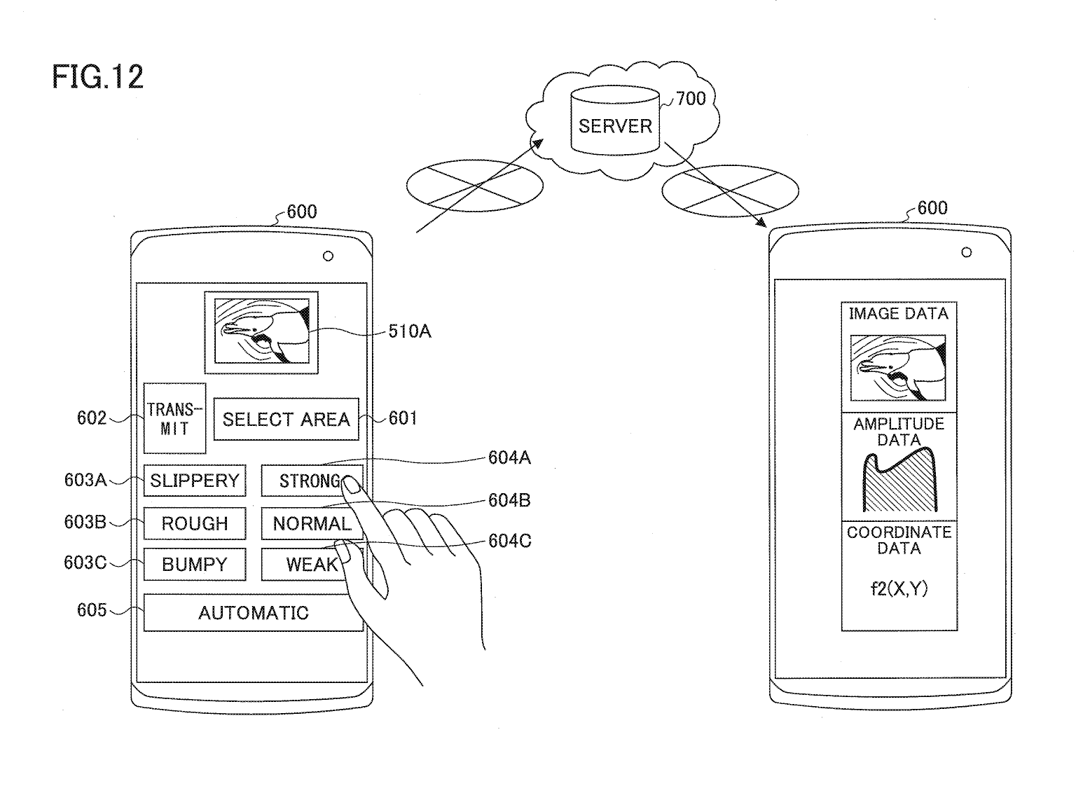

FIG. 12 is a diagram illustrating procedures when accessing the server 700 from the smartphone terminal 600 to create the tactile sensation data. The smartphone terminal 600 illustrated in FIG. 12 is executing an application for creating the tactile sensation data. The image 510A, an area selecting button 601, a transmitting button 602, tactile sensation selecting buttons 603A, 603B, and 603C, vibrating level setting buttons 604A, 604B, and 604C, and an automatic button 605 are displayed on the display panel 160. These buttons are realized by GUI components.

The user manipulates the touch panel 150 of the smartphone terminal 600 to select a photograph of which tactile sensation data is desired to be created. For example, the user drags and selects, from the selected photograph, an area of which tactile sensation data is desired to be created, and manipulates the area selecting button 601 to settle the manipulation. In FIG. 12A, it is supposed that the image 510A of the dolphin is selected and the area selecting button 601 is manipulated.

The user manipulates any of the tactile sensation selecting buttons 603A, 603B, and 603C to select a tactile sensation, and selects any of the vibration level selecting buttons 604A, 604B, and 604C to select a vibration level.

Here, the tactile sensation selecting buttons 603A, 603B, and 603C are GUI buttons for selecting a slippery tactile sensation, a rough tactile sensation, and a bumpy tactile sensation, respectively. The vibration level selecting buttons 604A, 604B, and 604C are buttons for selecting a strong vibration level, a normal vibration level, and a weak vibration level of three stages, respectively. The selection of the vibration level may be realized by selecting the amplification factor (see FIG. 7B) when the tactile sensation providing apparatus 100 drives the vibrating element 140.

After completing the selection of the tactile sensation(s) and the vibration level(s), the user manipulates the transmitting button 602. Thereby, the data of the image 510A and the data representing, the tactile sensation(s) and the vibration level(s), are transmitted to the server 700 via the network and the tactile sensation data is created by the server 700.

The user downloads the tactile sensation data to the smartphone terminal 600. The downloaded tactile sensation data is stored in the memory of the smartphone terminal 600.

The tactile sensation data can be created by an automatic mode. When the user selects the image 510A, manipulates the automatic button 605, and manipulates the transmitting button 602, the data of the image 510A is transmitted to the server 700 via the network. In the server 700, patterns are made by performing image processing such as binarization processing to the image 510A and vibration patterns are automatically calculated in accordance with the binarized data to create the tactile sensation data.

It is also possible to download, to the smartphone terminal 600, such tactile sensation data automatically created. A right side of FIG. 12 schematically illustrates a situation where the tactile sensation data including the image data of the dolphin, the amplitude data of the dolphin, and the coordinate data f (X,Y) of the dolphin is downloaded to the smartphone terminal 600.

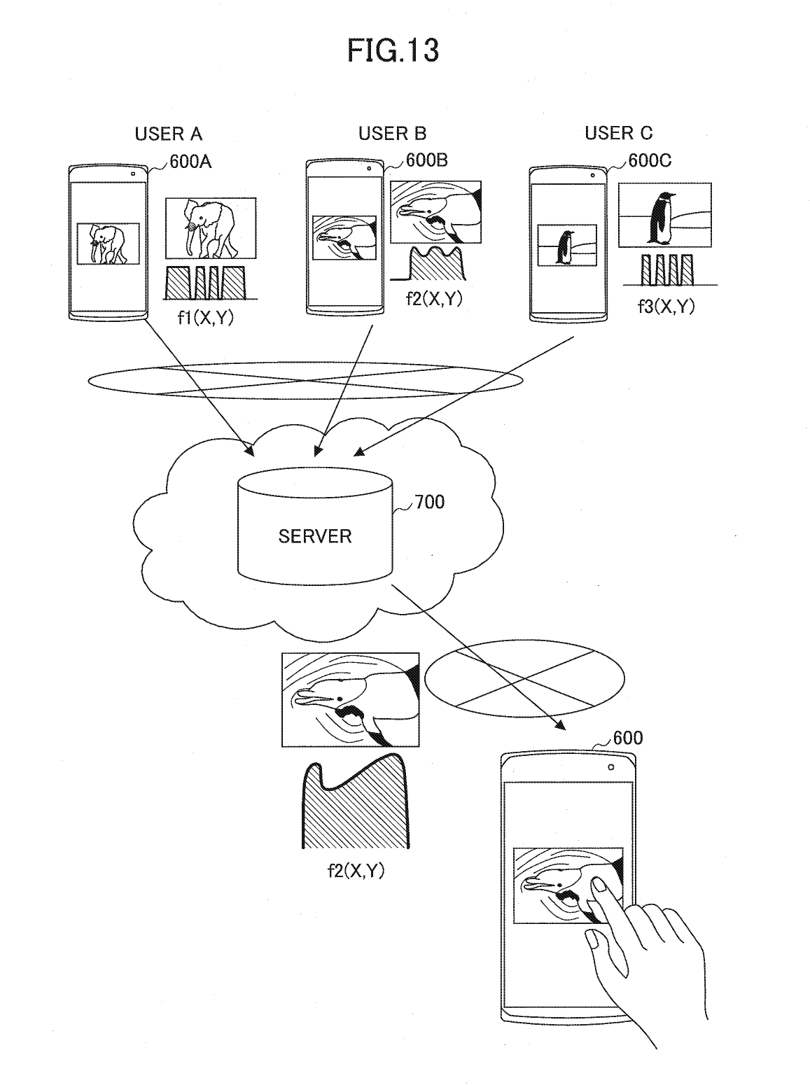

FIG. 13 is a diagram illustrating an environment where tactile sensation data of various users can be uploaded on the server 700 and can be freely downloaded.

The users A, B, and C use respective smartphone terminals 600A, 600B, and 600C to upload tactile sensation data to the server 700. The tactile sensation data of the user A includes an image of an elephant, amplitude data of the elephant, and coordinate data f1 (X,Y) of the elephant. The tactile sensation data of the user B includes an image of a dolphin, amplitude data of the dolphin, and coordinate data f2 (X,Y) of the dolphin. The tactile sensation data of the user C includes an image of a penguin, amplitude data of the penguin and coordinate data f3 (X,Y) of the penguin.

The tactile sensation of the user A, the tactile sensation of the user B, and the tactile sensation of the user C may be disclosed by the server 700 and may be bought and sold. Charging may be performed in accordance with a data amount when downloading the data.

The user of the smartphone terminal 600 downloads the tactile sensation data of the dolphin created by the user B, and stores the data in the inner memory.

Because the kinetic friction force applied to the user's fingertip is varied by generating the natural vibration in the ultrasound-frequency-band of the top panel 120, the tactile sensation providing apparatus 100 according to the first embodiment can provide the fine tactile sensations to the user.

The tactile sensation providing apparatus 100 of the first embodiment outputs the amplitude data in accordance with a position of the manipulation input by using the tactile sensation data that associates the coordinate data with the amplitude data. The coordinate data represents coordinates of the image in the image data. The amplitude data represents the amplitude values for adjusting the intensity of the driving signal used to drive the vibrating element 140.

Therefore, when the user traces the image of the target tangible object displayed on the display panel 160 of the tactile sensation providing apparatus 100, the tactile sensations can be provided to the user as if the user were tracing the actual surface of the target tangible object.

In particular, in a case where a target tangible object is an art object, a craft object, or the like and the actual object of that cannot be touched, usability is high because simulated tactile sensations can be experienced by using the tactile sensation providing apparatus 100 of the embodiment.

The tactile sensation providing apparatus 100 (see FIGS. 1 to 3) of the first embodiment generates the driving signal by causing the amplitude modulator 320 to modulate only the amplitude of the sinusoidal wave in the ultrasound-frequency-band output from the sinusoidal wave generator 310. The frequency of the sinusoidal wave in the ultrasound-frequency-band generated by the sinusoidal wave generator 310 is equal to the natural vibration frequency of the top panel 120. The natural vibration frequency is determined in consideration of the vibrating element 140.

The driving signal is generated by the amplitude modulator 320 modulating only the amplitude of the sinusoidal wave in the ultrasound-frequency-band generated by the sinusoidal wave generator 310 without modulating the frequency or the phase of the sinusoidal wave.

Accordingly, it becomes possible to generate the natural vibration of the top panel 120 in the ultrasound-frequency-band in the top panel 120 and to reduce the kinetic friction coefficient applied to the fingertip tracing the surface of the top panel 120 with absolute certainty by utilizing the layer of air provided by the squeeze film effect. It becomes possible to provide the fine tactile sensations to the user as if the concave portion and the convex portion were present on the surface of the top panel 120 by utilizing the Sticky-band Illusion effect or the Fishbone Tactile Illusion effect.

In the embodiment as described above, in order to provide the tactile sensations to the user as if the concave portions and the convex portions were present on the top panel 120, the vibrating element 140 is switched on or off. Turning off the vibrating element 140 is equal to setting the amplitude value represented by the driving signal used to drive the vibrating element 140 to zero.

However, it is not necessary to turn off the vibrating element 140 from a turned on state in order to provide such tactile sensations. For example, the vibrating element 140 may be driven based on the drive signal having a small amplitude instead of turning off the vibrating element 140. For example, the tactile sensation providing apparatus 100 may provide the tactile sensations to the user as if the concave portion and the convex portion were present on the surface of the top panel 120 by reducing the amplitude to about one-fifth of that of the turned on state.

In this case, the vibrating element 140 is driven by the drive signal in a manner that the vibration of the vibrating element 140 is switched between a strong level and a weak level. As a result, the strength of the natural vibration generated in the top panel 120 is switched between the strong level and the weak level. It becomes possible to provide the tactile sensations to the user's fingertip as if the concave portion and the convex portion were present on the surface of the top panel 120.

If the tactile sensation providing apparatus 100 turns off the vibrating element 140 when making the vibration weaker in order to switch the vibration of the vibrating element 140 from the strong level to the weak level, the vibrating element 140 is switched off. Switching on and off the vibrating element 140 means driving the vibrating element 140 intermittently.

According to the first embodiment as described above, the tactile sensation providing apparatus 100 that can provide the fine tactile sensations to the user can be provided.

Although the embodiment provides the tactile sensations of the dolphin, the target tangible object may be any tangible object such as various art objects, museum goods, craft objects, paintings, books, Buddha statues, bronze statues, stone statues, creatures, natural objects, and artificial objects.

Although the user can privately have the tactile sensation providing apparatus 100 to use the tactile sensation providing apparatus 100 at any place, the tactile sensation providing apparatus 100 may be installed in various places such as a museum, an art museum, a school, a library, and a commercial facility.

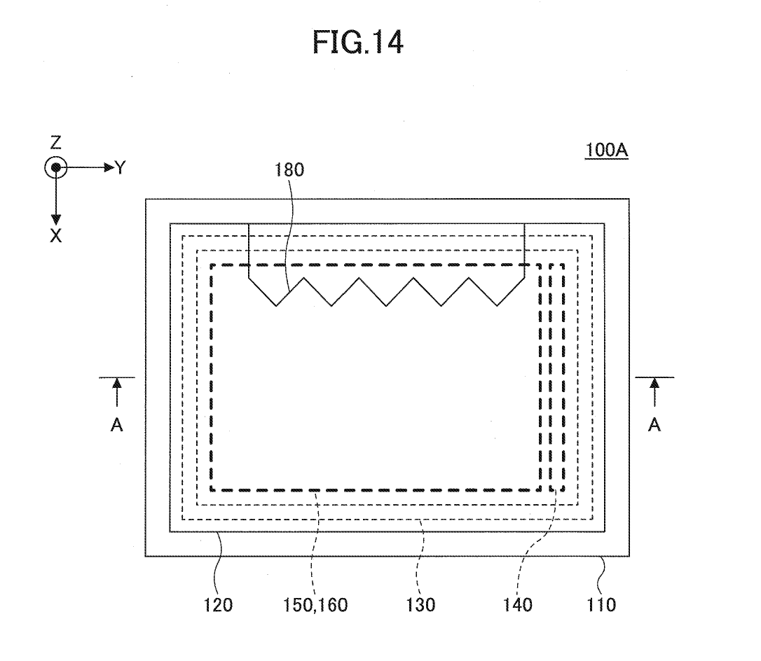

FIG. 14 is a diagram illustrating a tactile sensation providing apparatus 100A according to a first variation example of the first embodiment.

In the tactile sensation providing apparatus 100A, a heater 180 is added to the tactile sensation providing apparatus 100 illustrated in FIGS. 1 to 3. Other configurations of the tactile sensation providing apparatus 100A are similar to the configurations of the tactile sensation providing apparatus 100 illustrated in FIGS. 1 to 3.

The heater 180 (see FIG. 14) is disposed on a back face side of the top panel 120 in order to control a temperature of the surface of the top panel 120. For convenience of description, FIG. 14 illustrates one heating wire as the heater 180. However, the heater 180 may be provided all over the face of the top panel 120. The heater 180 may be disposed on the back side of the touch panel 150 or the back side of the display panel 160. The heater 180 may be a resistant form transparent conductive film, an alloy heater such as a nickel alloy heater, or the like. For example, the heater 180 may increase the temperature from an ambient temperature to about 60° C.

An element that can lower the temperature to a temperature lower than the ambient temperature such as a Peltier element may be used instead of the heater 180 or in addition to the heater 180.

For example, in a case of displaying a warm object as a target tangible object, by causing the user to sense warmth in addition to the tactile sensations based on the vibrations, more realistic tactile sensations can be provided to the user. Likewise, in a case of displaying a cold object as a target tangible object, by causing the user to sense coldness in addition to the tactile sensations based on the vibrations, more realistic tactile sensations can be provided to the user.

A set temperature of the heater 180 may be a predetermined fixed temperature depending on a kind of the target tangible object. In a case where tactile sensations of a target tangible object having a temperature distribution depending on regions, a plurality of heaters 180 may be provided and temperature data that represents a set temperature of each heater 180 may be added to the tactile sensation data to express the temperature distribution of the target tangible object.

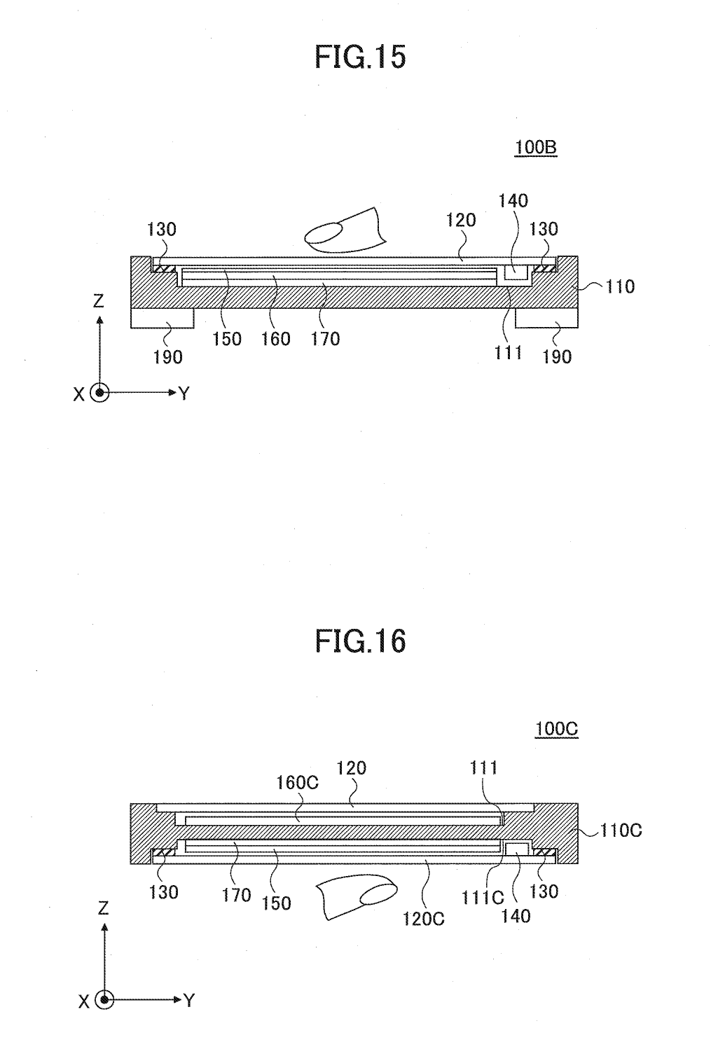

FIG. 15 is a diagram illustrating a tactile sensation providing apparatus 100B according to a second variation example of the first embodiment.

In the tactile sensation providing apparatus 100B, actuators 190 are added to the tactile sensation providing apparatus 100 illustrated in FIGS. 1 to 3. Other configurations of the tactile sensation providing apparatus 100B are similar to the configurations of the tactile sensation providing apparatus 100 illustrated in FIGS. 1 to 3.

The actuators 190 are disposed on a back face side of the housing 110 (negative side in Z axis direction). For example, four actuators 190 are disposed on respective four corners in plan view. For example, the actuators 190 are driven by a driving signal at frequencies in an audible frequency band.

For example, a linear actuator using a servomotor or a stepping motor may be used for the actuator 190. The actuators 190 vibrate the whole of the tactile sensation providing apparatus 100B. The audible frequency band is a frequency band about less than 20 kHz. For example, the actuators 190 are driven by a driving signal of several dozen Hz order. It is preferable that such actuators 190 can generate displacement about 100 μm to 1 mm, for example. The drive controlling part 240 or an equivalent drive controlling part may drive the actuators 190.

In this way, when the tactile sensation providing apparatus 100B itself vibrates, the vibration in which the natural vibration in the ultrasound-frequency-band by the vibration of the vibrating element 140 and the vibration in the audible frequency band by the actuators 190 are combined can be provided to the user's fingertip touching the surface of the top panel 120.

Depending on the feel on a surface of a target tangible object, there may be a case where more realistic tactile sensations can be provided by adding the vibration in the audible frequency band to the vibration of the standing wave caused by the natural vibration in the ultrasound-frequency-band.

In such a case, the tactile sensation providing apparatus 100B according to the second variation example is effective.

The actuator 190 does not have to be the linear actuator using the servomotor or the stepping motor. An electric driving element, an oil hydraulic driving element, a pneumatic driving element, a piezoelectric actuator, an artificial muscle or the like may be used.

FIG. 16 is a diagram illustrating a tactile sensation providing apparatus 100C according to a third variation example of the first embodiment. The cross section as illustrated in FIG. 16 corresponds to the cross section taken along the line A-A as illustrated in FIG. 3. In FIG. 16, a XYZ coordinate system, which is a rectangular coordinate system, similar to that illustrated in FIG. 3 is defined.

The tactile sensation providing apparatus 100C includes a housing 110C, the top panel 120, a panel 120C, the double-faced adhesive tape 130, the vibrating element 140, the touch panel 150, a display panel 160C, and the substrate 170.

The tactile sensation providing apparatus 100C includes a configuration in which the touch panel 150 of the tactile sensation providing apparatus 100 illustrated in FIG. 3 is provided on the back face side (negative side in Z axis direction). Thus, in comparison with the tactile sensation providing apparatus 100 illustrated in FIG. 3, the double-faced adhesive tape 130, the vibrating element 140, the touch panel 150, and the substrate 170 are disposed on the back face side.

A concave portion 111 at a positive side in z axis direction and a concave portion 111C at a negative side in z axis direction are formed on the housing 110C. The display panel 160 is disposed inside of the concave portion 111 and is covered with the top panel 120. The substrate 170 and the touch panel 150 are layered and disposed inside of the concave portion 111C. The panel 120C is secured to the housing 110C with the double-faced adhesive tape 130. The vibrating element 140 is disposed on a positive side surface of the panel 120C in z axis direction.

When the on/off state of the vibrating element 140 is switched to generate the natural vibration in the ultrasound-frequency-band in the panel 120C in accordance with the manipulation input onto the panel 120C in the tactile sensation providing apparatus 100C illustrated in FIG. 16, similar to the tactile sensation providing apparatus 100 illustrated in FIG. 3, the tactile sensation providing apparatus 100C can be provided with which the user can sense exchange of pictorial symbols (goods) displayed on the display panel 160C through the fingertip.

The tactile sensation providing apparatus 100C may be used instead of the tactile sensation providing apparatus 100 illustrated in FIGS. 1 to 3. FIG. 16 illustrates the tactile sensation providing apparatus 100C in which the touch panel 150 is provided on the back face side. However, the touch panels 150 may be provided on both the front face side and the back face side by combining the structure illustrated in FIG. 3 and the structure illustrated in FIG. 16.

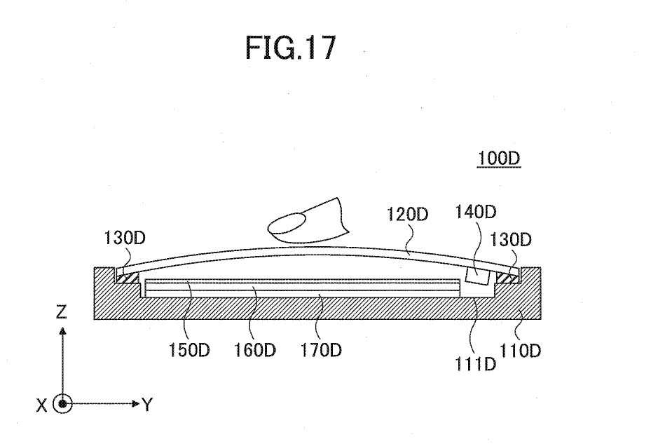

FIG. 17 is a diagram illustrating an operating state of a tactile sensation providing apparatus 100D of a fourth variation example according to the first embodiment.

The tactile sensation providing apparatus 100D includes a housing 110D, a top panel 120D, a double-faced adhesive tape 130D, a vibrating element 140D, a touch panel 150D, a display panel 160D and a substrate 170D.

The tactile sensation providing apparatus 100D illustrated in FIG. 17 has a configuration similar to that of the tactile sensation providing apparatus 100 of the first embodiment illustrated in FIG. 3 except for the top panel 120D being a curved glass.

The top panel 120D is curved so that its center portion in plan view protrudes towards a positive side in z axis direction. Although FIG. 17 illustrates a cross-section shape of the top panel 120D in a YZ plane, a cross-section shape in a XZ plane is similar to the cross-section shape in the YZ plane.

It is possible to provide the fine tactile sensations to the user by using the top panel 120D of the curved glass. In particular, it is effective for a case where a surface of a target tangible object is curved.

### Second Embodiment

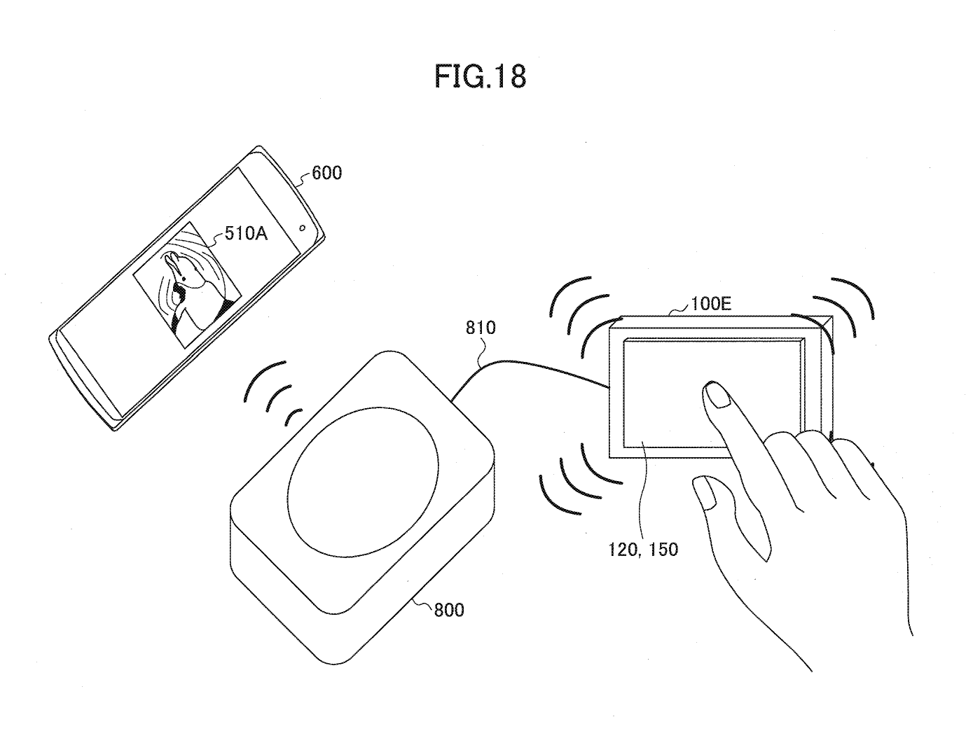

FIG. 18 is a diagram illustrating procedures until the user of a tactile sensation providing apparatus 100E of a second embodiment obtains the tactile sensation data.

In FIG. 18, the user transmits the tactile sensation data on the image 510A of the dolphin to the tactile sensation providing apparatus 100E via the short distance wireless communication apparatus 800. This illustrates a state where the tactile sensation providing apparatus 100E is used instead of the tactile sensation providing apparatus 100 according to the first embodiment illustrated in FIG. 11. In FIG. 18, the charging apparatus 820 is omitted.

The tactile sensation providing apparatus 100E differs from the tactile sensation providing apparatus 100 of the first embodiment in that the tactile sensation providing apparatus 100E does not include the display panel 160. Further, the tactile sensation data (see FIG. 7A) does not have to include the position data and the coordinate data because the tactile sensation providing apparatus 100E does not include the display panel 160 and does not perform driving in accordance with a manipulation position of the touch panel 150.

Because other configurations are similar to the configurations of the tactile sensation providing apparatus 100 of the first embodiment, same reference numerals are given to the similar elements and their descriptions are omitted.

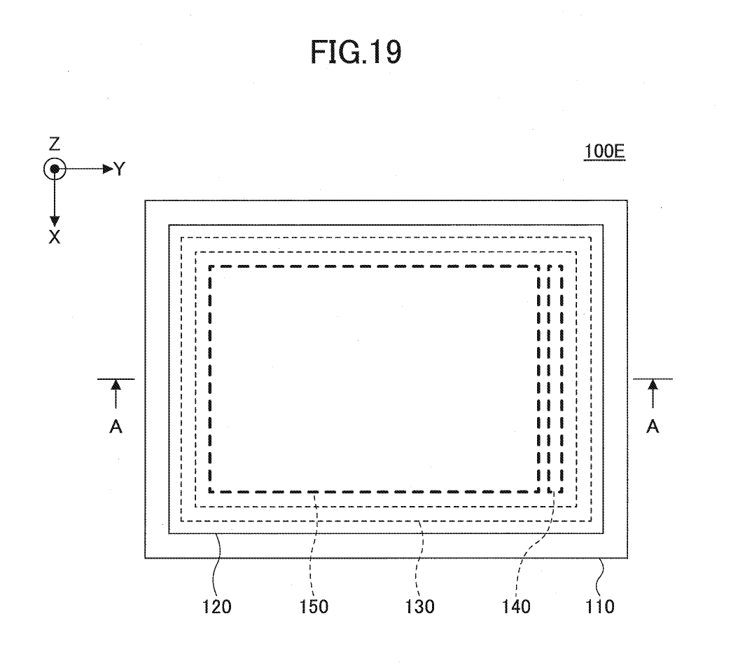

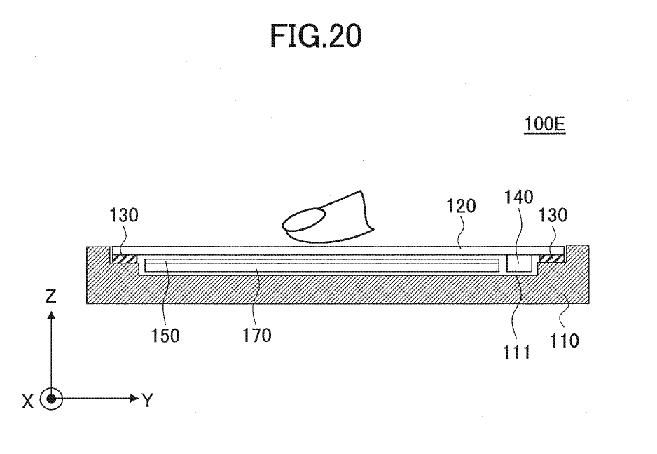

FIG. 19 is a diagram illustrating the tactile sensation providing apparatus 100E of the second embodiment in plan view. FIG. 20 is a diagram illustrating a cross-sectional view of the tactile sensation providing apparatus 100E taken along a line A-A of FIG. 19. A XYZ coordinate system as an orthogonal coordinate system is defined as illustrated in FIGS. 19 and 20.

The tactile sensation providing apparatus 100E includes the housing 110, the top panel 120, the double-faced adhesive tape 130, the vibrating element 140, the touch panel 150, and the substrate 170. The touch panel 150 is directly mounted on the substrate 170 in the tactile sensation providing apparatus 100E.

When the manipulation input is performed on the top panel 120, the drive controlling part 240 of the tactile sensation providing apparatus 100E drives the vibrating element 140 by using a driving signal of an amplitude based on the tactile sensation data.

In the second embodiment, the touch panel 150 is provided to detect the manipulation input being performed by the user and a movement of the position of the manipulation input. Accordingly, when the manipulation input is performed on the top panel 120 and it is detected, based on the position data output from the driver IC 151, that the position of the manipulation input moves, the tactile sensation providing apparatus 100E uses the amplitude data of the tactile sensation data to drive the vibrating element 140.

For example, in a case where the tactile sensation data of the dolphin is input to the tactile sensation providing apparatus 100E, the vibrating element 140 is driven by a driving signal that reproduces a feel of a skin of the dolphin. For example, in a case where it is desired to reproduce only the feel of the skin of the dolphin, the tactile sensation providing apparatus 100E, which does not include the display panel 160 and has a simple configuration, can provide fine tactile sensations to the user.

Because the kinetic friction force applied to the user's fingertip is varied by generating the natural vibration in the ultrasound-frequency-band of the top panel 120, the tactile sensation providing apparatus 100E according to the second embodiment can provide the fine tactile sensations to the user. Such a tactile sensation providing apparatus 100E is effective for a case where tactile sensations of a surface of a target tangible object are substantially constant.

When the tactile sensation providing apparatus 100E is installed at a location where people gather such as a restaurant or a cafe for example, the user can obtain the tactile sensations through the tactile sensation providing apparatus 100E as if the user were touching a surface of a dolphin even if the actual dolphin (see FIG. 1) is not present at the location.

In such a case, charging may be performed in accordance with a data communication amount between the smartphone terminal 600 and the short distance wireless communication apparatus 800, a number of times of use of the short distance wireless communication apparatus 800 or the tactile sensation providing apparatus 100E, a utilization time of the short distance wireless communication apparatus 800 or the tactile sensation providing apparatus 100E or the like. Without using the short distance wireless communication apparatus 800, the wire communication via a direct cable or data transmission via a transportable recording medium such as a flash memory card can be performed between the tactile sensation providing apparatus 100E and the smartphone terminal 600.

The tactile sensation providing apparatus 100E may include a sensor that detects contact on the top panel 120 instead of including the touch panel 150. In this case, the sensor may detect that the user touches the top panel 120, and the vibrating element 140 may be driven. A pressure sensor or the like may be used as the sensor, for example.

In a case where the display panel 160 is not included as described above, a mark may be displayed on the top panel 120, the tactile sensation data may include coordinate data of positions of the mark, and the vibrating element 140 may be driven by using an amplitude in accordance with the position of the manipulation input.

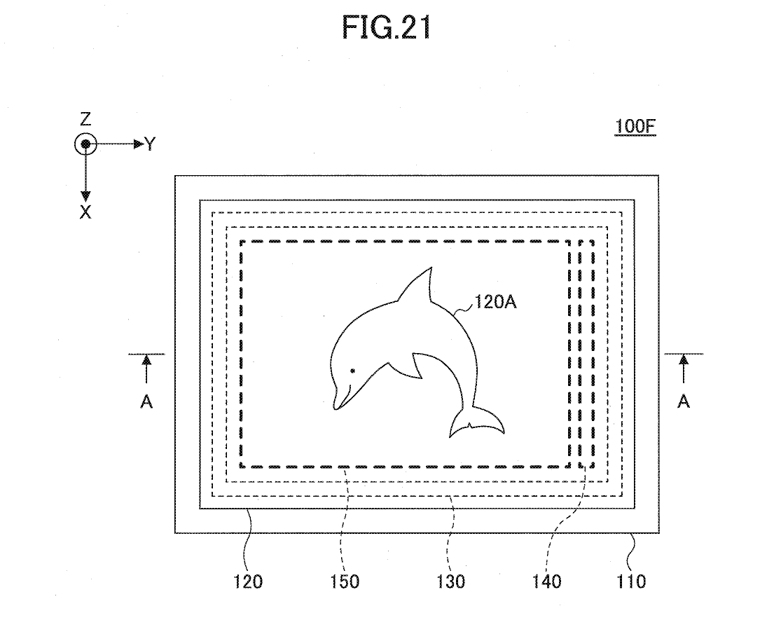

FIG. 21 is a diagram illustrating a tactile sensation providing apparatus 100F according to a variation example of the second embodiment in plan view. In the tactile sensation providing apparatus 100F, a mark 120A of a dolphin is provided on the top panel 120 of the tactile sensation providing apparatus 100E illustrated in FIG. 19. Coordinate data that represents positions of the mark 120A of the dolphin is included in the tactile sensation data.

When the manipulation input is performed within the mark 120A of the dolphin, similar to the tactile sensation providing apparatus 100 of the first embodiment, the drive controlling part 240 drives the vibrating element 140 by using a driving signal of an amplitude in accordance with a position of the manipulation input.

Because the kinetic friction force applied to the user's fingertip is varied by generating the natural vibration in the ultrasound-frequency-band of the top panel 120, the tactile sensation providing apparatus 100F according to the variation example of the second embodiment can provide the fine tactile sensations to the user.

Although the embodiment is described in which the mark 120A of the dolphin is printed on the surface of the top panel 120, marks (such as marks representing the points A to D in FIGS. 8A and 8B, for example) corresponding to one or more points of an actual surface of a target tangible object may be provided on the surface of the top panel 120.

Various point services, prize services or the like may be performed in accordance with a degree of use.

Although examples of a tactile sensation providing apparatus and a system according to the embodiments of the present invention have been described, the present invention is not limited to the embodiments specifically disclosed and various variations and modifications may be made without departing from the scope of the present invention.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the sprit and scope of the invention.

What is claimed is:

1. A tactile sensation providing apparatus comprising:
a top panel having a manipulation input surface;
a position detector configured to detect a position of a manipulation input performed on the manipulation input surface to output a signal in accordance with the manipulation input;
a display part disposed on a back face side of the top panel;
a first vibrating element configured to generate a vibration in the manipulation input surface of the top panel;
a memory configured to store tactile sensation data in which an image of a target tangible object is associated with positions in the image and amplitudes corresponding to tactile sensations of the target tangible object at the respective positions; and
a drive controlling part configured to drive the first vibrating element by using a driving signal causing the first vibrating element to generate a natural vibration in an ultrasound-frequency-band in the manipulation input surface,
wherein the tactile sensation data, downloaded by a mobile terminal of a user from a server via a network, is input from the mobile terminal of the user, and
wherein the drive controlling part adjusts an amplitude of the driving signal based on the position of the manipulation input performed on the manipulation input surface and a position among the positions in the image included in the tactile sensation data.

2. The tactile sensation providing apparatus as claimed in claim 1, wherein the drive controlling part drives the first vibrating element so as to vary an intensity of the natural vibration in accordance with the position of the manipulation input and a temporal change degree of the position of the manipulation input performed on the manipulation input surface.

3. A tactile sensation providing apparatus comprising:
a top panel having a manipulation input surface;
a position detector configured to detect a position of a manipulation input performed on the manipulation input surface to output a signal in accordance with the manipulation input;
a first vibrating element configured to generate a vibration in the manipulation input surface of the top panel;
a memory configured to store tactile sensation data in which positions in the manipulation input surface are associated with amplitudes corresponding to tactile sensations of a target tangible object at the respective positions; and
a drive controlling part configured to drive the first vibrating element by using a driving signal causing the first vibrating element to generate a natural vibration in an ultrasound-frequency-band in the manipulation input surface,
wherein the tactile sensation data, downloaded by a mobile terminal of a user from a server via a network, is input from the mobile terminal of the user, and
wherein the drive controlling part adjusts an amplitude of the driving signal based on the position of the manipulation input performed on the manipulation input surface and a position among the positions in the manipulation input surface included in the tactile sensation data.

4. The tactile sensation providing apparatus as claimed in claim 3, wherein a mark that represents a position of the target tangible object is provided on the manipulation input surface.

5. The tactile sensation providing apparatus as claimed in claim 1, further comprising:
a temperature adjusting element configured to adjust a temperature of the manipulation input surface.

6. The tactile sensation providing apparatus as claimed in claim 1, further comprising:
a second vibrating element configured to generate a vibration at an audible frequency in the manipulation input surface.

7. The tactile sensation providing apparatus as claimed in claim 1, wherein the tactile sensation data stored in the memory is input from the mobile terminal connected through a wired or wireless connection.

8. The tactile sensation providing apparatus as claimed in claim 1, wherein the tactile sensation data is created by the server based on data of the image transmitted to the server from the mobile terminal of the user.

9. A system comprising:
a mobile terminal; and
a server configured to perform communication with the mobile terminal,
wherein the server transmits, to the mobile terminal, tactile sensation data of a target tangible object in response to a request from the mobile terminal, and
wherein the mobile terminal inputs the tactile sensation data received from the server to the tactile sensation providing apparatus as claimed in claim 1.
